(19) United States
(12) Patent Application Publication
(10) Pub. No.: US 2013/0316122 A1
(43) Pub. Date: Nov. 28, 2013

(54) METHOD FOR PARTIAL LAMINATION OF FLEXIBLE SUBSTRATES

(71) Applicants: Manfred Gresch, Neu-Anspach (DE); Josef Roth, Bessenbach (DE); Siegfried Walter, Geinhausen-Hochst (DE); Gerd Buschmann, Nidderau (DE); Udo Becker, Steinau (DE)

(72) Inventors: Manfred Gresch, Neu-Anspach (DE); Josef Roth, Bessenbach (DE); Siegfried Walter, Geinhausen-Hochst (DE); Gerd Buschmann, Nidderau (DE); Udo Becker, Steinau (DE)

(73) Assignee: HERAEUS MATERIALS TECHNOLOGY GMBH & CO. KG, Hanau (DE)

(21) Appl. No.: 13/984,570

(22) PCT Filed: Jan. 16, 2012
(86) PCT No.: PCT/EP2012/000154

§ 371 Date: Aug. 9, 2013

(30) Foreign Application Priority Data
Feb. 10, 2011 (DE) 10 2011 010 984.6

(51) Int. Cl. B32B 38/00; B32B 38/06; B32B 3/10

(52) U.S. Cl. CPC B32B 38/0004; B32B 3/10; B32B 38/06
USPC 428/78; 156/219; 156/256; 156/252; 156/510

(57) ABSTRACT

A method for producing a laminate made up of at least two films/foils is provided. At least one first film/foil is structured and subsequently laminated to at least one second film/foil. The at least one second film/foil is punched by at least one tool in a single working step and is laminated to the structured first film/foil simultaneously. The films/foils are conveyed, at least part of the time, to the at least one tool. A laminate produced according to such a method and a device for producing a laminate using such a method are also provided. The device is suited for conveying and laminating the at least one first and second films/foils, wherein regions of the films/foils are aligned to be parallel with respect to each other. The device includes at least one tool that can be used to punch-laminate second film/foil onto the first film/foil.

### CROSS-REFERENCE TO RELATED APPLICATIONS

This application is a Section 371 of International Application No. PCT/EP2012/000154, filed Jan. 16, 2012, which was published in the German language on Aug. 16, 2012, under International Publication No. WO 2012/107157 A1 and the disclosure of which is incorporated herein by reference.

### BACKGROUND OF THE INVENTION

The invention relates to a method for producing a laminate made up of at least two films/foils, wherein at least one first film/foil is structured and subsequently laminated to at least one second film/foil.

The invention also relates to a laminate produced according to the method and to a device for producing a laminate using the method.

Laminates made up of two films/foils have wide applicability in industry. In this context, for example, a metal foil is laminated onto a plastic film or between two plastic films. The films/foils are structured during this process in order to obtain the desired product. It is known from International Application Publication No. WO 92/15118 to apply two film/foil webs onto each other in appropriate manner, such that punch markers of the one film/foil web are arranged at the same site of the film/foil laminate as the punch markers of the second film/foil web. For this purpose, the position of the punch markers is monitored and any offset between the punch markers of the two film/foil webs is corrected after a measurement is made. In addition, a tensile stress may be applied to the one film/foil web, such that the resulting stretching of the film/foil web contributes to correcting the offset.

A method of this type necessitates extensive equipment. Moreover, it is associated with a problem related to firmly connecting two film/foil webs to each other under such starting conditions, because thermo-mechanical tension between the two film/foil webs arises in this type of film/foil laminate once the tensile force is released or after equilibration of the temperatures of the two film/foil webs is reached, thereby possibly leading to deformation of the film/foil laminate and detachment of the two film/foil webs from each other.

A similar method is known from German Patent No. DE 29 39 014 A1, in which the positions of the two film/foil webs with respect to each other are regulated by changing the feed rate of the film/foil webs.

A method for laminating at least two films/foils is known from German Patent No. DE 44 42 920 A1, in which a first film/foil, in the form of consecutive individualized film/foil web sections, and a second film/foil, in the form of a continuous film/foil web, are guided to each other. The film/foil web sections are arranged in sequence and separate from each other at defined positions of the continuous film/foil web and are glued to it. This eliminates the problem of an increasing offset when two continuous film/foil webs are being glued together.

This method is disadvantageous in that the individual film/foil web sections need to be fed individually, which requires high equipment needs and very high precision in the implementation of the method. This method is associated with high costs for the apparatus and the individual steps of the process might be slowed down.

### BRIEF SUMMARY OF THE INVENTION

It is therefore an object of the invention to overcome the disadvantages of the prior art. Specifically, a simple and inexpensive method for forming the laminate is to be found. At the same time, it must be feasible to arrange the structures of the laminates to be positioned exactly over each other. Another object of the invention is to provide a device that can be used to produce a laminate of this type, and to deliver a laminate produced in this manner.

Objects of the invention are met in that at least one second film/foil is punched by at least one tool in a single working step and is laminated to the structured first film/foil simultaneously, wherein the films/foils are conveyed, at least part of the time, to the at least one tool.

In the context of the invention, punching and laminating in a single working step should be understood to mean that the process steps of punching and laminating proceed concurrently, at least part of the time. It is irrelevant in this context whether or not the segment of the second film/foil to be punched out detaches from the second film/foil before the segment to be punched is pressed on, or if the films/foils are first connected to each other and the film/foil segment only then detaches from the second film/foil. This effect can be attained in this context, for example, in that the same tool, which possesses sharp edges for punching-out one of the second films/foils, also presses the surface of the second film/foil onto the first film/foil. Accordingly, the working step can be defined in that the feed, or the force as it may be, is used both for pressing-on at least one second film/foil and for punching at least one second film/foil. It can even be particularly preferable to provide heat concurrently by the tool in order to attach at least one second film/foil on the first film/foil.

In one embodiment, the first film/foil may also be structured through embossing and/or punching-out, in particular before the punch-lamination.

If the first film/foil and the second film/foil (or second films/foils) are embossed and/or punched before the punch-lamination, the tool must be positioned appropriately, such that the punching die of the second film(s)/foil(s) matches the embossings and punching dies (structures) of the first film/foil. The embossings and punching dies can be helpful in the positioning of the tool. Moreover, incorrect embossing and incorrect punching of the first film/foil are made easier to recognize before laminating the films/foils.

Moreover, according to an embodiment of the invention, search holes are punched into the first film/foil as position markers before the punch-lamination and the at least one tool engages the search holes by at least one guide pin, and is thus positioned with respect to the first film/foil before the at least one second film/foil is punched and laminated to the structured first film/foil by the at least one tool.

These measures ensure exact alignment of the film/foil structures with respect to each other.

According to one embodiment of the invention, the planar second film(s)/foil(s) is/are not be structured before the punch-lamination.

Producing all structures using the punch-lamination reduces the number of working steps, and thus renders the production method safer and more cost-efficient.

Particularly advantageous refinements of the method result from providing that the first film/foil and the at least one second film/foil are aligned to be parallel with respect to each other, at least over regions thereof, and are preferably conveyed over at least two rollers. The films/foils are punch-laminated in the region in which they are aligned to be parallel with respect to each other. Also, the films/foils preferably are aligned to be parallel with respect to each other, preferably at a distance of 1 mm to 30 mm, more preferably at a distance of 5 mm to 15 mm, and most preferably at a distance of 10 mm, wherein the parallel alignment refers to the surface of the films/foils per se, but not necessarily to the direction of feed as well.

The parallel alignment is advantageous in that the punch-lamination can proceed in simple and precise manner. Since this allows the design of the tool to be simple, costs can be reduced.

According to a further embodiment, at least two second films/foils may be punch-laminated onto the first film/foil, wherein the punch-lamination of the second films/foils proceeds consecutively and/or in pairs on both sides.

This method can be used to build-up a sandwich structure by which the internal first film/foil of the laminate thus produced is well-protected.

According to a particularly advantageous embodiment, at least one continuous film/foil may be used as first and second films/foils, and preferably all films/foils are processed in the form of continuous films/foils.

This is advantageous in that continuous processing of the method is enabled, which can be implemented in particularly efficient manner in an embodiment of the method according to the invention.

In the context of the present invention, a continuous film/foil is not to be understood to be a film/foil of truly never-ending length, but a film/foil whose length is very large as compared to its width. For this purpose, the films/foils are usually reeled onto rotatable rolls and are unreeled while the method is being implemented. According to one embodiment of the present invention, the film/foil webs can have a length of 1 to 1,000 meters, but can just as well be even longer. In this context, it may be crucial that the reeled-up rolls of film/foil can still be inserted into the device. Alternatively, it would just as well be feasible to implement the method downstream of the film/foil manufacturing process at the same factory.

The invention can also provide that the films/foils adhere to each other at a part of their contact surfaces in a first step during the punch-lamination, and are glued to each other across their entire surface in a second step.

The second step then proceeds not exactly concurrently to the first step during the punch-lamination. However, the two steps usually overlap in an embodiment of the method according to the present invention.

An embodiment of the present invention can just as well provide the films/foils to be glued to each other by thermal means or mechanism.

Thermal gluing of the films/foils is easy to combine with the punch-lamination. For this purpose, the tool is either heated on the side, on which at least one of the second films/foils is punched out, or the counterpart is heated; i.e., the support on which, for example, the first film/foil rests.

Another particularly preferred embodiment of the invention can provide a metal foil to be used as first film/foil and/or a plastic film to be used as second film(s)/foil(s) or multiple plastic films to be used as second films/foils.

The method according to the invention is particularly rapid and easy to use in the case of metal-plastic laminates. Such materials are also well-suited for mass production of laminates.

An object of the invention is also met by a laminate produced using a method of this type. The laminate itself is also a subject matter of an embodiment of the invention.

Moreover, an object of the invention is met by a device for producing a laminate using a method of this type, which provides that the device is well-suited for conveying and laminating a first film/foil and at least one second film/foil, wherein regions of the films/foils are aligned to be parallel with respect to each other and wherein the device comprises at least one tool that can be used to punch-laminate at least one second film/foil onto the first film/foil. The parallel alignment in this context refers to the surface of the films/foils as such, but not necessarily to the direction of feed as well.

The device is well-suited for implementing a method according to an embodiment of the present invention, and is therefore also considered to be included in the scope of the invention.

In this context, the invention can provide that a laminating surface or a support, which is preferably arranged on the side of the films/foils opposite to a punching tool of the tool, configured to be heated, and preferably provides the tool to comprise a heating system for heating the laminating surface, in particular an electrical heating system.

The tool may also comprise at least one guide pin for positioning the tool in search holes of the first film/foil.

It is particularly advantageous for the films/foils to be continuous films/foils and/or for the device to be well-suited for conveying and laminating films/foils of this type. The attendant advantages have been discussed in the context of the use of continuous films/foils in a method according to an embodiment of the present invention.

According to a particularly advantageous embodiment of the present invention, the first film/foil may be a metal foil and the second film(s)/foil(s) may be plastic film(s).

Moreover, the tool(s) may be arranged in the region(s) in which the films/foils are aligned to be parallel with respect to each other.

Finally, the at least one tool may comprise a punching edge and a laminating surface.

The invention is based on the surprising finding that punch-lamination can proceed in a single step. This is advantageous in that a simple process is thus enabled. The device needed for implementing the method preferably needs just one central punching-laminating tool. As a result, the films/foils can even have different conveying directions, since it is feasible according to an embodiment of the present invention to let the entire punch-lamination proceed at a single site only.

Especially the alignment of the tool with respect to the first film/foil plays an important role in this context, provided the first film/foil is structured already. For this purpose, search holes can be provided as structuring in the first film/foil to be engaged by at least one guide pin of the tool, which ensures correct positioning of the tool with respect to the structures of the first film/foil. The effect of this is that the structures generated by the tool in the at least one second film/foil are arranged exactly at the correct position with respect to the structures in the first film/foil.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

Exemplary embodiments of the invention are illustrated in the following based on four schematic figures, though without limiting the scope of the invention. In the figures:

In the drawings:

FIG. 1 shows a schematic cross-sectional view of a first device according to an embodiment of the invention for a method according to an embodiment of the invention;

FIG. 2 shows a schematic view of a laminate according to an embodiment of the invention that has been produced using a method according to an embodiment of the invention;

FIG. 3 shows a schematic perspective view of a second device according to an embodiment of the invention for a method according to an embodiment of the invention; and

FIG. 4 shows a schematic cross-sectional view of the second device shown in FIG. 3.

### DETAILED DESCRIPTION OF THE INVENTION

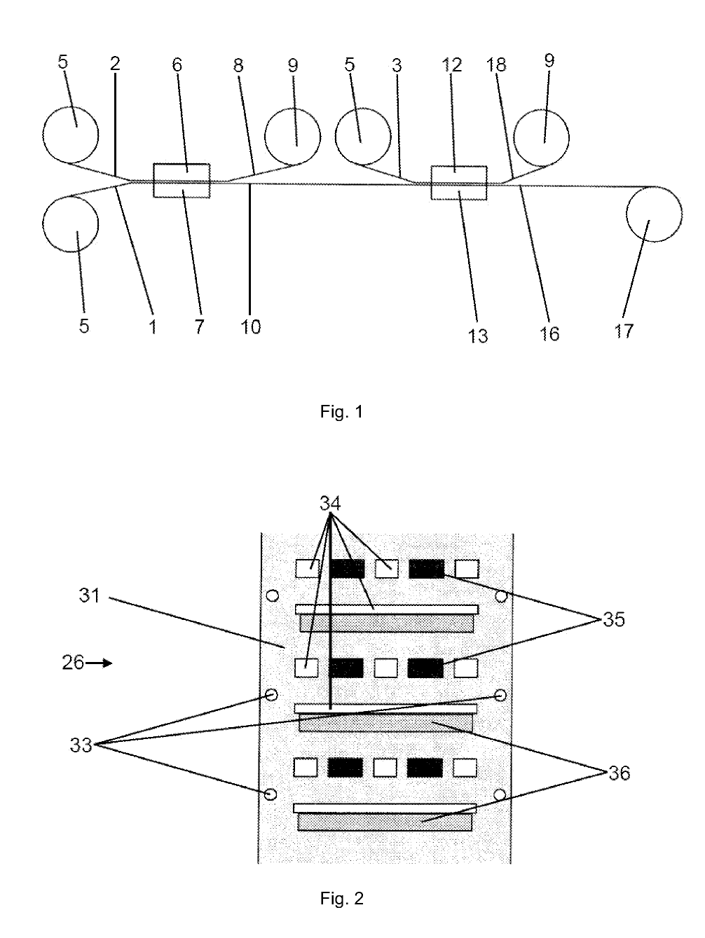

FIG. 1 shows a schematic cross-sectional view of a first device according to an embodiment of the invention for producing a laminate. A first film/foil 1, a second film/foil 2, and a third film/foil 3 are fed to the device. The films/foils 1, 2, 3 are reeled-up on rolls 5 and are unreeled off the rolls 5 and fed to the device.

The first film/foil 1 is pre-punched and reeled-up on the lower roll 5. The first film/foil 1 and the second film/foil 2 are unreeled and fed to the device. For this purpose, the films/foils 1, 2 are redirected in appropriate manner, such that they are guided to be parallel in a first region at a distance of approximately 5 mm. A first tool 6 of the device is arranged in the first region. The tool 6 comprises a heatable base surface 7 over which the first film/foil 1 runs.

In the region of the tool 6, the second film/foil 2 is applied onto the first film/foil 1 and is punched-out in the process. The punched-out segments of the second film/foil 2 are then situated on the first film/foil 1. Due to the temperature of the base surface 7 being elevated, the punched-out segment of the second film/foil 2 becomes firmly connected, or laminated as the case may be, to the first film/foil 1. The remainder of the second film/foil 2, from which the segments were punched-out, is reeled-up on a take-up roll 9 as a first residual film/foil 8.

The film/foil 10 laminated to the segments of the second film/foil 2 is transported to a second tool 12 that comprises a second base surface 13. An adhesive (not shown) is applied to the singly laminated film/foil 10 before it enters the second tool 12. Alternatively, the third film/foil 3 can also be coated with an adhesive.

The second tool 12 is used to punch-laminate the third film/foil 3 onto the first film/foil 1 or the singly laminated film/foil 10, as the case may be. As a result, a laminate 16 is produced that is being taken-up onto a laminate roll 17. The remainder of the third film/foil 3 is taken-up on a take-up roll 9 as a residual film/foil 18.

FIG. 2 shows a schematic view of a fully built-up laminate 26 made from a first film/foil 31, a second film/foil, and a third film/foil. The first film/foil 31 is a punched metal tape, in which various recesses are provided. The recesses are in a periodical arrangement.

Circular search holes 33 are provided at the edges of the metal tape 31 and serve, preferably exclusively, for position determination of a tool (not shown) that is used to produce the laminate 26. For this purpose, two guide pins (not shown) of the tool engage the search holes 33.

Aside from the recesses arranged as search holes 33 in the punched metal tape 31, there are recesses 34 that are not covered (i.e. are left as exposed recesses), recesses 35 that are laminated to the second film/foil, and recesses 36 that are laminated to the third film/foil.

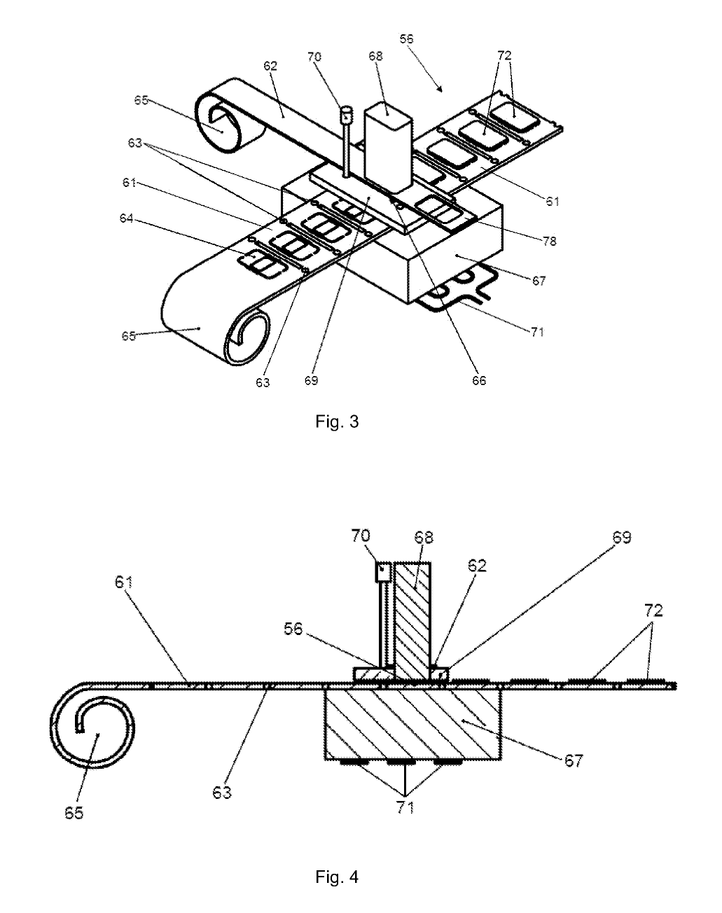

FIGS. 3 and 4 show schematic views of a second device according to an embodiment of the invention for implementing a method according to an embodiment of the invention and for producing a laminate 56 according to an embodiment of the invention. Specifically, FIG. 3 shows a schematic perspective view and FIG. 4 shows a schematic cross-sectional view.

A laminate 56 is built-up from a first punched metal tape 61 and a plastic film 62. The metal tape 61 has search holes 63, embossings 64 and/or recesses 64. The two films/foils 61, 62 are reeled off of rolls 65 and are fed to the device at a right angle with respect to each other. The device comprises a tool 66 that is used to laminate the plastic film 62 to the punched metal tape 61.

The tool 66 comprises a heated support 67 that is used for thermal lamination of the plastic film 62 on the metal tape 61. The plastic film 62 is punched-out by a stamp 68 and a die 69 of the tool 66 and pressed onto the top surface of the metal tape 61. The tool 66 further comprises a guide pin 70 that is guided through a recess in the die 69.

The purpose of the guide pin 70 is to correctly position the tool 66 with the punched piece from plastic film 62 with respect to the metal tape 61. For this purpose, the guide pin 70 automatically engages the search holes 63 of the metal tape 61. The process of punch-lamination by the device proceeds only when the guide pin 70 is lowered into or through one of the search holes 63. Holes are provided in the support 67 for this purpose, such that the guide pin 70 can be lowered through the search holes into the holes of the support 67. After the punch-lamination, the guide pin 70 is retracted again from the search holes 63 and the two films/foils 61, 62 are conveyed further. A sensor (not shown) can be provided in the hole(s) of the support 67 and allows for testing of whether or not the guide pin 70 is inserted. Alternatively, the position of the guide pin 70 can be measured in the region of the die 69, for example, through inductive means.

The films/foils 61, 62 are arranged to be parallel with respect to each other in the region of the tool 66. The support 67 is heated by a heating system 71. The heating system 71 can be a resistance-type heating system or a heat exchanger of a gas heating system.

The heating system 71 firmly connects the punched-out segments 72 of the plastic film 62 to the metal tape 61, and thus produces the laminate 56. The remainder of the plastic film 62 is drawn out of the device as a residual film/foil 78.

Accordingly, the laminate 56 is produced in one working step by punch-laminating the plastic film 62 onto the metal tape 61 on the inside of the tool 66. This is indicated in FIG. 4, in which the newly produced laminate 56 is on the inside of the tool 66.

The features of the invention disclosed in the preceding description as well as the claims, figures, and exemplary embodiments, can be essential to the implementation of the various embodiments of the invention either alone or in any combination thereof.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-15. (canceled)

16. A method for producing a laminate (10, 16, 26, 56) comprising at least two films/foils (1, 2, 3, 31, 61, 62), the method comprising:
structuring at least one first film/foil (1, 31, 61); and
subsequently laminating the at least one first film/foil (1, 31, 61) to at least one second film/foil (2, 3, 62),
wherein the at least one second film/foil (2, 3, 62) is punched by at least one tool (6, 12, 66) in a single working step and is laminated to the structured first film/foil (1, 31, 61) simultaneously, and
wherein the at least one first and second films/foils (1, 2, 3, 31, 61, 62) are conveyed, at least part of the time, to the at least one tool (6, 12, 66).

17. The method according to claim 16, wherein the at least one first film/foil (1, 31, 61) is structured by embossing and/or punching-out.

18. The method according to claim 16, wherein search holes (33, 63) are punched into the at least one first film/foil (1, 31, 61) as position markers before the punch-lamination, and wherein the at least one tool (6, 12, 66) engages the search holes (33, 63) by at least one guide pin (70), such that the at least one tool is positioned with respect to the at least one first film/foil (1, 31, 61) before the at least one second film/foil (2, 3, 62) is punched and laminated to the structured first film/foil (1, 31, 61) by the at least one tool (6, 12, 66).

19. The method according to claim 16, wherein the at least one second film/foil (2, 3, 62) is planar second films/foils (2, 3, 62) and is not structured before the punch-lamination.

20. The method according to claim 16, wherein the at least one first film/foil (1, 31, 61) and the at least one second film/foil (2, 3, 62) are aligned to be parallel with respect to each other at least over a region thereof, wherein the at least one first and second films/foils (1, 2, 3, 31, 61, 62) are conveyed over at least two rollers, wherein the at least one first and second films/foils (1, 2, 3, 31, 61, 62) are punch-laminated in the region in which they are aligned to be parallel with respect to each other, and wherein the at least one first and second films/foils (1, 2, 3, 31, 61, 62) are aligned to be parallel with respect to each other at a distance of 1 mm to 30 mm.

21. The method according to claim 16, wherein at least two second films/foils (2, 3, 62) are punch-laminated onto the at least one first film/foil (1, 31, 61), and wherein the punch-lamination of the two second films/foils (2, 3, 62) proceeds consecutively and/or in pairs on both sides.

22. The method according to claim 16, wherein one continuous film/foil (1, 2, 3, 31, 61, 62) is used as the at least one first and second films/foils (1, 2, 3, 31, 61, 62).

23. The method according to claim 16, wherein the at least one first and second films/foils (1, 2, 3, 31, 61, 62) are thermally glued to each other.

24. The method according to claim 16, wherein a metal foil (31, 61) is used as the at least one first film/foil (1, 31, 61) and/or a plastic film (62) is used as the at least one second film/foil (2, 3, 62).

25. A laminate (10, 16, 26, 56) produced using the method according to claim 16.

26. A device for producing a laminate (10, 16, 26, 56) using the method according to claim 16, the device comprising the at least one tool (6, 12, 66) configured to punch-laminate the at least one second film/foil (2, 3, 62) onto the at least one first film/foil (1, 31, 61),
wherein the device is configured to convey and laminate the at least one first and second films/foils (1, 2, 3, 31, 61, 62), and
wherein regions of the at least one first and second films/foils (1, 2, 3, 31, 61, 62) are aligned to be parallel with respect to each other.

27. The device according to claim 26, wherein a laminating surface (7, 13) and/or a support (67) arranged on a side of the at least first and second films/foils (1, 2, 3, 31, 61, 62) opposite to a punching tool (68) of the at least one tool (6, 12, 66) is configured to be heated, and wherein the at least one tool (6, 12, 66) comprises a heating system (71) for heating the laminating surface (7, 13).

28. The device according to claim 26, wherein the at least one tool (6, 12, 66) comprises at least one guide pin (70) for positioning the at least one tool (6, 12, 66) in search holes (33, 63) of the at least one first film/foil (1, 31, 61).

29. The device according to claim 26, wherein the at least one first film/foil (1, 31, 61) is a metal foil (31, 61) and the at least one second film/foil (2, 3, 62) is a plastic film (62).

30. The device according to claim 26, wherein the at least one tool (6, 12, 66) is arranged in a region in which the at least one first and second films/foils (1, 2, 3, 31, 61, 62) are aligned to be parallel with respect to each other, and/or wherein the at least one tool (6, 12, 66) comprises a punching edge and a laminating surface (7, 13).
